(19) United States
(12) Patent Application Publication
(10) Pub. No.: US 2009/0307122 A1
(43) Pub. Date: Dec. 10, 2009

(54) System and Method of Online Auction of Real Estate Options

(75) Inventor: Kyle David Bach, South Bend, IN (US)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: Mecca Companies, Inc., Mishawaka, IN (US)

(21) Appl. No.: 12/136,408

(22) Filed: Jun. 10, 2008

(51) Int. Cl. G06Q 30/00; G06F 17/30

(52) U.S. Cl. 705/37; 705/35; 707/104.1; 707/E17.005

(57) ABSTRACT

A system and method of obtaining offers for an option in one embodiment includes obtaining an option to purchase a real property, storing tax credit data associated with future development of the real property in a database, storing option data associated with the obtained option in the database, associating the stored option data with the stored tax credit data, retrieving the stored option data and the stored tax credit data, displaying the retrieved data, requesting an offer for the option associated with the displayed data, and receiving an offer to purchase the obtained option.

### FIELD OF THE INVENTION

This invention relates to real estate options and more specifically to real estate options for properties within Qualified Census Tracts (QCTs).

### BACKGROUND

Tax credits are incentives offered by either the federal or state governments to induce contributions and investments from the private sector into projects that benefit targeted communities and populations. One tax credit program is the low income housing tax credit (LIHTC) program. The LIHTC program is an indirect Federal subsidy used to encourage the development of affordable rental housing for low-income households. A tax credit provides a reduction of taxpayer liability in the jurisdiction issuing the credit.

Federal housing tax credits under the LIHTC program are awarded to developers of “qualified” projects. To qualify for consideration of receipt of tax credits under the LIHTC Program, a proposed project must: (1) be a residential rental property; (2) commit to one of two possible low-income occupancy threshold requirements; (3) restrict rents, including utility charges, in low-income units, and (4) operate under the rent and income restrictions for 30 years or longer, pursuant to written agreements with the agency issuing the tax credits.

Each year, the IRS allocates specific numbers of housing tax credits to designated state agencies, typically state housing finance agencies. Each state is limited to a total annual housing tax credit allocation based upon the state population, with only the first year of the 10 years of tax credits counting against the allocation. States and local jurisdictions may also offer tax credits to offset state and/or local taxes to encourage various types of development projects.

In order to provide the greatest return on the available tax credits, the entities allocating the tax credits have devised processes for assessing proposed developments. Developers are required to submit detailed proposals including information about the experience of the developer, financial plans for the proposed development, neighborhood and site information, market feasibility analysis, general contractor information and architectural and engineering plans.

The proposals received by the allocating authority are graded based upon a number of criteria which reflect the information that is required to be submitted. Generally, the amount of tax credits available cannot support the amount necessary for each of the proposals which meet a minimum eligibility grade. Accordingly, not all of the proposals are approved.

Generally, a planned development will not be undertaken if the proposal is not approved because the financial feasibility of most plans is generally substantially dependent upon the receipt of some amount of tax credits. By way of example, tax credits issued for a rental property development may be sold to investors at a discounted rate. The proceeds from the sale may then be used as the initial capital needed to fund the development project. The availability of initial capital reduces the debt incurred by the development, thereby reducing the amount of income from the development that is needed to service the debt. The reduction in debt service allows a lower rent to be charged, thereby achieving the goals of the tax credit program. The failure to obtain the tax credits thus eliminates a significant source of funding. The loss of funding is generally fatal to the planned development.

Accordingly, the market for housing tax credits is very complicated and very competitive. Additionally, identifying an appropriate property for a project can be a time consuming venture. The subsequent identification of information sources necessary to prepare a proposal based upon the particular property is also time consuming. Thus, a developer has typically made a significant investment of resources in a project before drafting of a specific proposal is even begun.

What is needed is a method of identifying properties that may qualify for development under one or more tax credit programs. Providing information which can be used by a developer to assess the potential of the identified property would be beneficial. Providing information that can be used to prepare and submit a proposed development of the property would also be useful. A need also exists for a method of providing a developer the opportunity to obtain an option to the property.

### SUMMARY

In accordance with one embodiment, there is provided a method of obtaining offers for an option in one embodiment includes obtaining an option to purchase a real property, storing tax credit data associated with future development of the real property in a database, storing option data associated with the obtained option in the database, associating the stored option data with the stored tax credit data, retrieving the stored option data and the stored tax credit data, displaying the retrieved data, requesting an offer for the option associated with the displayed data, and receiving an offer to purchase the obtained option.

In accordance with another embodiment, there is provided an option auction system including a network, a display operatively connected to the network, a memory in which command instructions are stored, and a processor configured to execute the command instructions to store tax credit data associated with future development of a real property; store option data associated with an obtained option, associate the stored option data with the stored tax credit data, retrieve the stored option data and the stored tax credit data, display the retrieved data, request an offer for the option associated with the displayed data, and store a received offer to purchase the obtained option.

In accordance with a further embodiment, an option auction system includes a network connection, a memory in which command instructions are stored, and a processor configured to execute the command instructions to (i) store development data for a plurality of real properties, (ii) store a plurality of option data, each of the plurality of option data associated with an obtained option for an associated one of the plurality of real properties, (iii) associate the stored development data with the associated real property, (iv) retrieve the plurality of real properties and the associated stored development data, (v) transmit the retrieved plurality of real properties and the associated stored development data through the network connection, (vi) request a plurality of offers, each of the requested plurality of offers associated with one of the retrieved plurality of real properties, (vii) store a received offer to purchase one of the retrieved plurality of real properties.

### BRIEF DESCRIPTION OF THE DRAWINGS

FIG. 1 depicts a schematic view of an option auction system incorporating principles of the invention;

FIG. 2 depicts an exemplary welcome page rendered on a user display in response to accessing the auction information system of FIG. 1;

FIG. 3 depicts an exemplary user specific page rendered on a user display in response to entering a user specific password in the welcome page of FIG. 2;

FIG. 4 depicts a portion of an exemplary property specific page including development data unique to a specific property and general data applicable to the specific property rendered on a user display in response to selecting one of the properties listed on user specific page of FIG. 3;

FIG. 5 depicts another portion of the property specific page of FIG. 4;

FIG. 6 depicts an expanded portion of the property specific page of FIGS. 4 and 5 showing listing data unique to the specific property and listing data generally applicable to the specific property rendered on a user display in response to expanding a data filed of the property specific page of FIGS. 4 and 5; and

FIG. 7 depicts an expanded portion of the property specific page of FIGS. 4 and 5 showing contact data applicable to the specific property rendered on a user display in response to expanding a data filed of the property specific page of FIGS. 4 and 5.

### DESCRIPTION

For the purposes of promoting an understanding of the principles of the invention, reference will now be made to the embodiments illustrated in the drawings and described in the following written specification. It is understood that no limitation to the scope of the invention is thereby intended. It is further understood that the present invention includes any alterations and modifications to the illustrated embodiments and includes further applications of the principles of the invention as would normally occur to one skilled in the art to which this invention pertains.

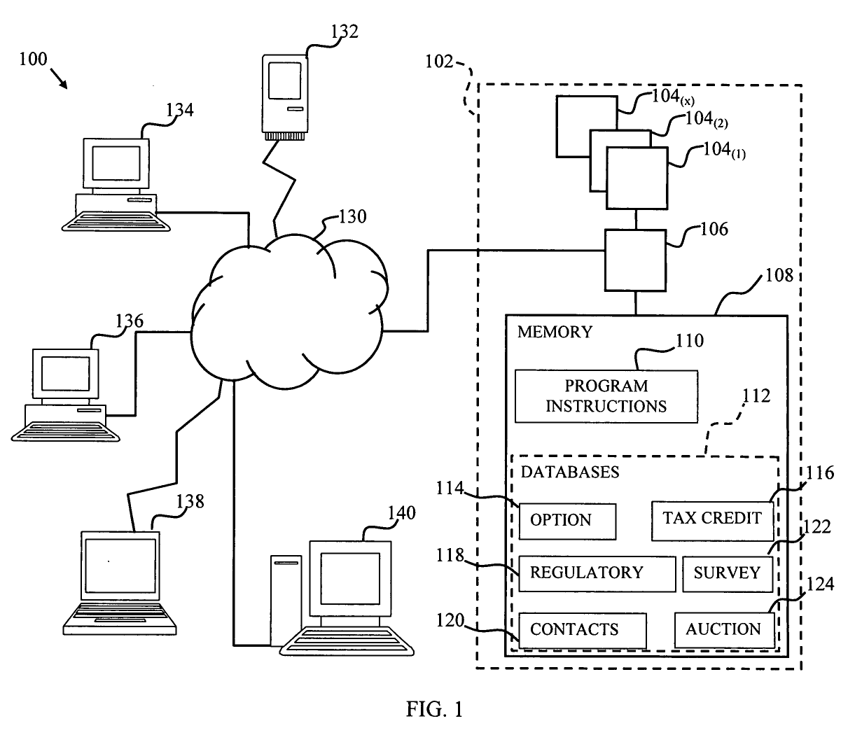

An option auction system 100 is shown in FIG. 1. The auction system 100 includes an option information system 102 with local I/O devices 104, a processing circuit 106 and a memory 108. The I/O devices 104 may include a user interface, graphical user interface, keyboards, pointing devices, remote and/or local communication links, displays, and other devices that allow externally generated information to be provided to the processing circuit 106, or that allow internal information of the option information system 102 to be communicated externally.

The processing circuit 106 may suitably be a server or general purpose computer processing circuit such as a microprocessor and its associated circuitry. The processing circuit 106 is operable to carry out the operations attributed to it herein. Program instructions 110 are stored within the memory 108 along with databases 112. The program instructions 110, which are described more fully below, are executable by the processing circuit 106 and/or any other components as appropriate.

The databases 112 are used to store development data. Development data as used herein means data related to the future development of a property, wherein the property is associated with an option to purchase the property. The development data includes data unique to the property as well as general data that apply to the property. Data unique to the property thus includes, for example, the price of the property, the zoning of the property, and the present condition of the property. General data includes data related to the approval process of development proposals, market surveys, contact data for the relevant municipality, etc.

In this embodiment, the databases 112 include an option database 114, a tax credit database 116, a regulatory database 118, a contacts database 120, a survey database 122, and an auction database 124. The data stored in the databases 112 may be stored in a single database or within separate databases as shown in FIG. 1. Additionally, while the databases 112 are shown within the memory 108, one or more of the database 112 may be in one or more memories remote from the memory 108. In one embodiment, the databases 112 are populated using object oriented modeling. The use of object oriented modeling allows for a rich description of the relationship between various objects.

The option database 114 includes data related to physical property on which an option to purchase is available. The data stored within the option data base 114 may include site characteristics, a site plan or survey/plat, sale price of the property, current condition of the property, address of the property, pictures of property, and other data specific to the property. For example, identification of the property as a historical site or prior uses of the property may be included.

The tax credit database 116 includes data associated with the potential for receiving tax credits for development of the property. Such data may include financial incentives available (i.e. tax abatement), special classifications that apply to the property (revitalization area, enterprise zone, etc.), community needs score, census tract data, and data identifying development goals of the relevant municipality.

The regulatory database 118 includes legal data associated with development of the property. The data stored within the regulatory database 118 includes zoning ordinances, building codes, proposal process data (e.g., deadlines, checklists, selection criteria self score data, etc.), fees assessed by the responsible municipality (e.g., sewer fees, permit fees, etc.).

The contacts database 120 includes contact information for various entities involved in the proposal process. The contacts for which data may be provided include municipal/regulatory contacts such as planning, engineering, and development entities.

The survey database 122 includes data associated with the area surrounding the property. Data which may be included in the survey database 122 includes infrastructure data, nearby stores, nearby amenities, nearby land use, map of the surrounding area, demographic reports and market analyses.

The auction database 124 includes data related to the conduct of an auction for the option to purchase the property. The data stored within the auction database 124 may include bid opening and closing times, bid activity, current bid amount, etc.

A communications network 130 provides communications between the option information system 102 and remote terminals 132, 134, 136, 138, and 140. In the embodiment described herein, the communications network 130 may be a direct dial connection, Intranet, Extranet, the Internet or World Wide Web (“WWW”), or other suitable communications path. A suitable network protocol, such as the TCP/IP protocol, may be used for the communications.

The remote terminals 132, 134, 136, 138, and 140 may be any type of computer which allows remote users to access the network 130. The remote terminals 132, 134, 136, 138, and 140 may include a central processor unit (“CPU”) and main memory, an input/output interface for communicating with various databases, files, programs, and networks, and one or more storage devices. The storage devices may be disk drive devices or CD ROM devices. The remote terminals 132, 134, 136, 138, and 140 may also have a monitor or other screen device and an input device, such as a keyboard or a mouse. The remote terminals 132, 134, 136, 138, and 140 may also have software programs contained in the main memory or the storage devices which can be used by the CPU such as a Web browser.

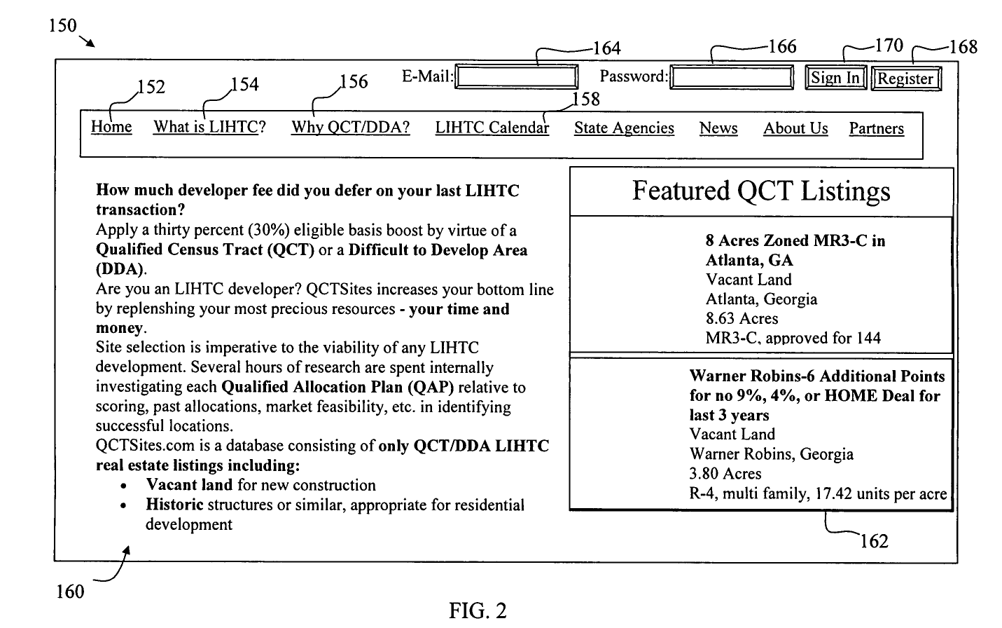

The processing circuit 106 allows access through the network 130 to various resources in the option information system 102. Upon initial access of the option information system 102 from a remote terminal 134, 136, 138, or 140, a welcome page 150 shown in FIG. 2 is displayed. The welcome page 150 includes public option buttons 152. The public option buttons 152 provide access to information which may be used by a new customer to better understand the resources of the option information system 102 that may be accessed through the welcome page 150.

Additional data may be provided on the welcome page 150 if desired. In the embodiment of FIG. 2, the welcome page 150 includes discussion field 160 and featured listing field 162. The discussion field 160 may be used to provide general information about the site or an inducement to register with the option information system 102. The featured listing field 162 provides a sampling of available options which are presented to generate interest in the resources available through the option information system 102. The featured listing field 162 is populated with data stored in the databases 112.

The welcome page 150 also includes an email box 164 and a password box 166 which are used to allow established customers access to non-public resources. New customers may obtain access to the option information system 102 resources by selection of the register button 168. Selection of the register button 168 causes registration pages (not shown) to be displayed to the user.

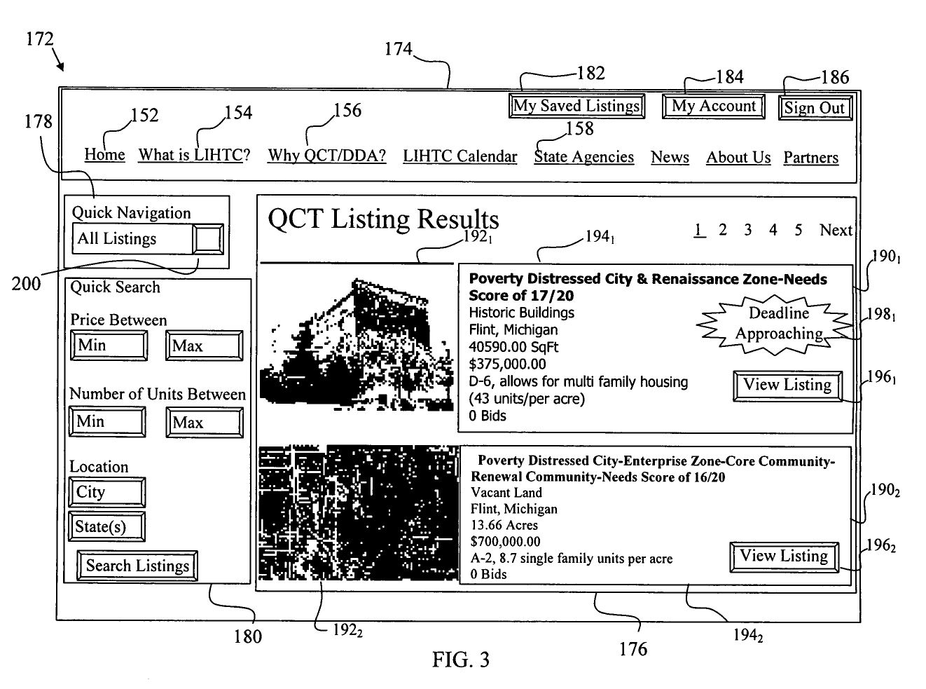

Access to the non-public resources is accomplished by entry of a previously registered email address in the email box 164 and an associated password in the password box 166. Once the appropriate input is entered into the email box 164 and the password box 166, the user selects the sign-in button 170. In response to the selection of the sign-in button 170, the option information system 102 causes a user specific page 172, shown in FIG. 3, to be displayed to the user.

The user specific page 172 includes an option pane 174, an auction pane 176, a navigation pane 178, and a search pane 180. The option pane 174 includes the public option buttons 152 as well as user specific option buttons 182, 184, and 186.

The auction pane 176, which may encompass a number of pages, includes option summary modules 190_{X}. The option summary modules 190_{X} identify properties associated with options that are available for purchase. With reference to option summary module 190₁, each of the option summary modules 190_{X} include a property image 192₁, a property summary 194₁, and a view listing button 196₁. Additional fields may be provided such as warning field 198₁ which, in this embodiment, is used to highlight an impending deadline associated with the property.

The option summary modules 190_{X} provide the user with basic information as to the nature of the property associated with a particular option. The property image 192_{X} is useful for identifying at a glance if the option is associated with a building (see, e.g., property image 192₁) or a plot of land (see, e.g., property image 192₂). The property image 192_{X} may be an actual photograph, a rendering, or an icon. Preferably, the property image 192_{X} is an actual photograph. The data for the property image 192_{X} is stored in the option database 114. The property summary 194_{X} includes a brief description of the physical characteristics of the property associated with the option, populated with data from the option database 114, some grading criteria for the property populated with data from the tax credit database 116, and a summary of the bid activity on the associated option populated with data from the auction database 124.

The navigation pane 178 includes a pull down button 200 which allows a user to filter the list of properties in the auction pane 176 according to the listing type. Accordingly, selection of the pull down button 200 allows a user to filter the list of properties to show only vacant land, only apartments, or only historic buildings. Similarly, the search pane 180 may be used to rapidly identify properties listed in the auction pane 176 that are within a specified price range, that are within a specified city or state, or by the number of units that may be developed on the property. Additional or different search and navigation options may be provided

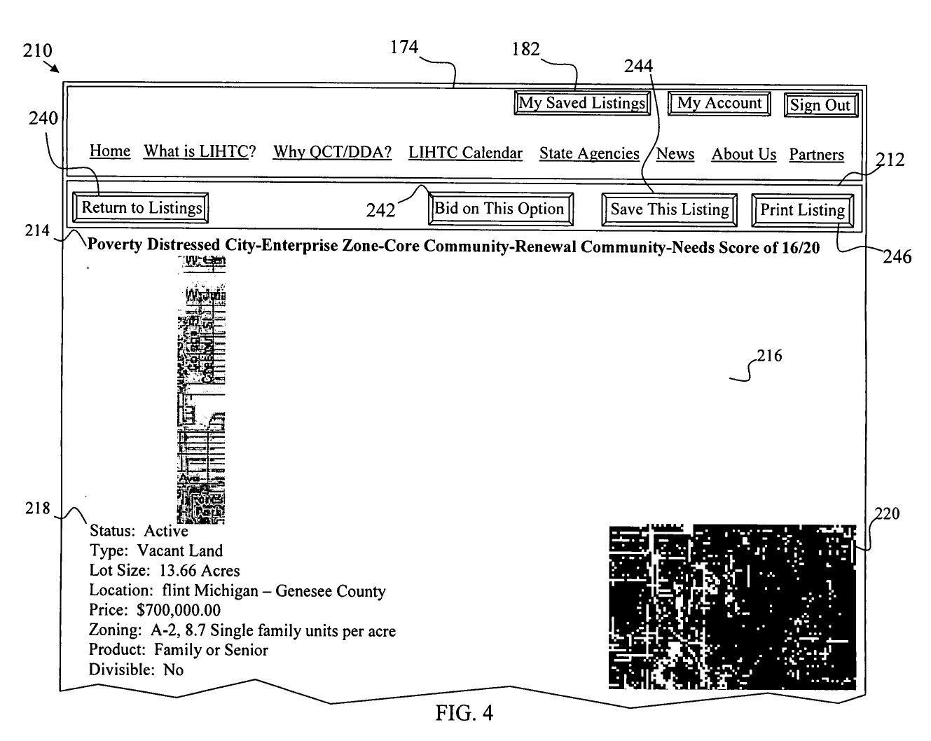

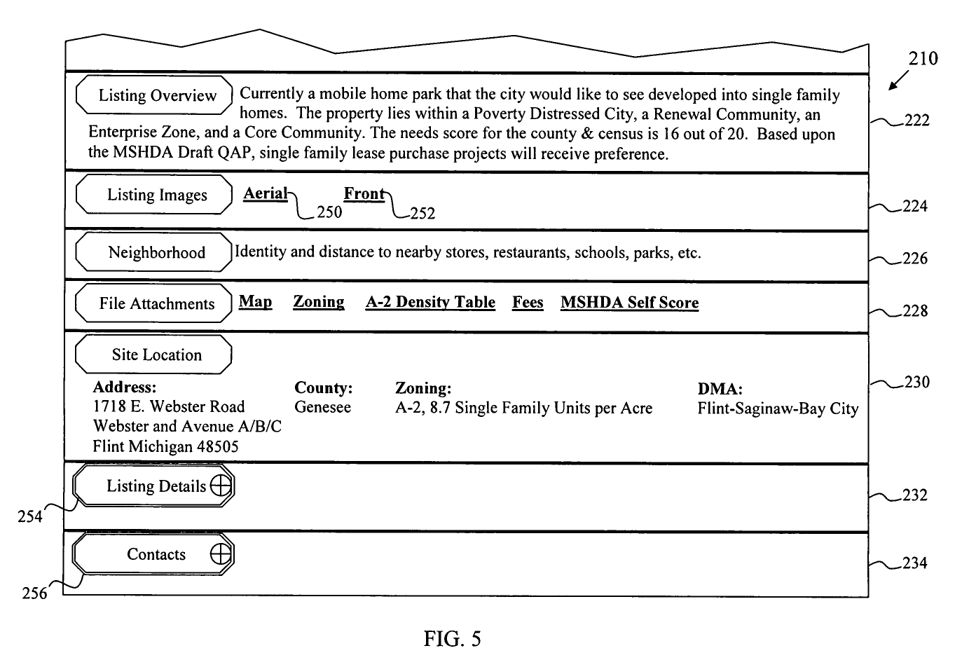

Once a user identifies a property of interest, the view listing button 196_{X} associated with the property is selected by the user. By way of example, a user interested in the property described in option summary module 190₂ may select the view listing button 196₂. In response to the selection of the view listing button 196₂, the option information system 102 causes the property specific page 210 shown in FIGS. 4-5 to be displayed to the user.

The upper portion of the property specific page 210 which is shown in FIG. 4 includes the option pane 174, a property specific option pane 212, a property title field 214, a map field 216, a detail summary field 218 and an image 220 of the property. The lower portion of the property specific page 210, shown in FIG. 5 includes data fields 222, 224, 226, 228, 230, 232, and 234.

The property specific option pane 212 includes a return to listings button 240, a bid button 242, a save button 244 and a print button 246. Selection of the return to listing button 240 results in the display of the user specific page 172. Selection of the bid button 240 results in the display of a bid page (not shown) which allows the user to identify a bid amount for an option and any special conditions attached to the bid. Selection of the save button 244 causes a link to the property specific page 210 to be displayed in response to selection of the user specific option button 182. Selection of the print button 246 results in the display of a printer friendly version of the property specific page 210 which the user may then print on a local printer.

The map field 216 displays a map of the location of the property. The map may be interactive and may incorporate aerial images of the location of the property. The data used to populate the map field 216 is stored in the survey database 122. Detail summary field 218 is populated with data similar to the data displayed in the property summary 194₂. The data may be obtained from one or more of the databases 112.

With reference to FIG. 5, the data field 222 provides additional detail as to the nature of the property. In this embodiment, a narrative of the present condition of the property as well as information as to the local needs score and development goals of the local municipality are provided. This data, which is stored in one or more of the databases 112, may be used by a developer to assess the potential of a property for future development.

The data field 224 includes two links 254 and 256 to images of the property. The links 254 and 256 are used to display data stored in the option database 114. The data may be used to render images showing various characteristics of the property. In alternative embodiments, the images are rendered on the property specific page.

The data field 226 provides data which is used to better understand the amenities which are located near the property. The amenities may include restaurants, shops, malls, stores, parks, etc. If desired, data may be presented in the form of a score or chart. Alternatively, a map with icons may be used. The information presented in the data field 226 may be stored in the survey database 122.

The data field 228 is used to provide links to documents which may be used to better assess the feasibility of developing the property. Links may be provided for regulatory documents stored in the regulatory database 118 such as zoning codes, housing codes, fee schedules and proposal submission guidelines. Links to documents such as market data and topographic surveys stored in the survey database 122 may also be accessed through the data field 228.

The data field 230 provides data as to the physical location of the property including local jurisdiction information that may be stored in the survey database 122. Zoning information from the regulatory database 118 may also be displayed.

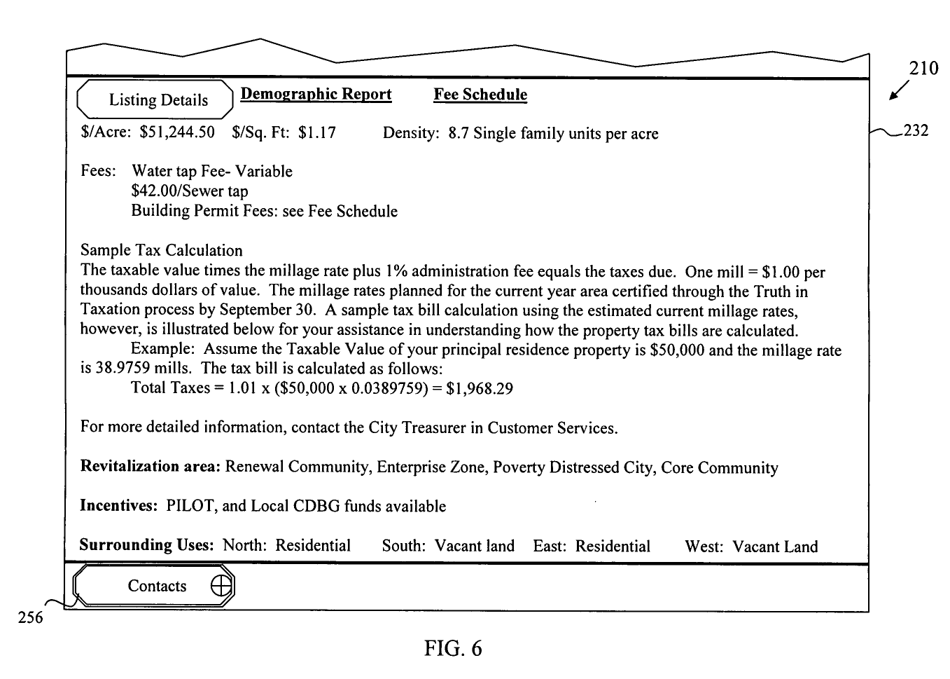

FIG. 6 shows the data field 232 after the listing details button 254 has been selected to expand the data field 232. The data field 232 includes links 260 and 262. The link 260 provides access to demographic report data stored in the survey database 122. The link 262 provides access to fee schedule data stored in the regulatory database 118. More or fewer links may be provided.

The data field 232 further displays data obtained from the databases 112 to provide more detailed information associated either directly or indirectly with the property. Thus, data such as cost data for the property, regulatory fees, tax information, special classifications or incentives that apply the property, and other data which may or may not be presented elsewhere may be displayed or linked to the data field 232.

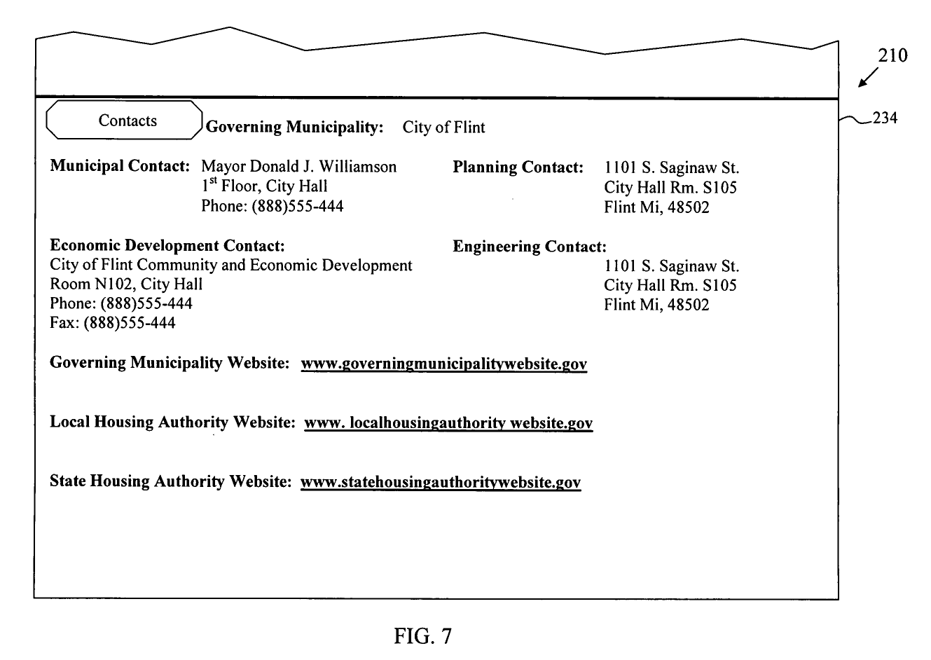

FIG. 7 shows the data field 234 after the contacts button 256 has been selected to expand the data field 234. The data field 234 is used to provide a developer with data for contacting the municipal entities associated with the property. These entities may include political entities and regulatory entities. Contact information may include physical addresses, telephone numbers, and web site addresses.

The option information system 102 thus provides a user with a plethora of data associated with a particular property. The data facilitates an evaluation of the fiscal viability of a development of the property. Using the data available through the option information system 102, an individual may identify a property which may viably be developed and submit a bid to purchase an option to the property. The information provided by the option information system 102 further facilitates the preparation and submission of a development proposal to a tax credit allocation entity.

While the invention has been illustrated and described in detail in the drawings and foregoing description, the same should be considered as illustrative and not restrictive in character. It is understood that only the preferred embodiments have been presented and that all changes, modifications and further applications that come within the spirit of the invention are desired to be protected.

1. A method of obtaining offers for an option comprising:
obtaining an option to purchase a real property;
storing tax credit data associated with future development of the real property in a database;
storing option data associated with the obtained option in the database;
associating the stored option data with the stored tax credit data;
retrieving the stored option data and the stored tax credit data;
displaying the retrieved data;
requesting an offer for the option associated with the displayed data; and
receiving an offer to purchase the obtained option.

2. The method of claim 1, further comprising:
storing regulatory data associated with the real property in the database;
associating the stored regulatory data with the stored option data; and
retrieving the stored regulatory data, wherein displaying the retrieved data comprises displaying the retrieved regulatory data.

3. The method of claim 1, further comprising:
storing municipal contact data associated with the real property in the database;
associating the stored municipal contact data with the stored option data; and
retrieving the municipal contact data, wherein displaying the retrieved data comprises displaying the retrieved municipal contact data.

4. The method of claim 1, further comprising:
storing surrounding area survey data associated with the real property in the database;
associating the stored surrounding area survey data with the stored option data; and
retrieving the surrounding area survey data, wherein displaying the retrieved data comprises displaying the retrieved surrounding area survey data.

5. The method of claim 1, further comprising:
storing first bid data for the option in the database; and
retrieving the first bid data, wherein displaying the retrieved data comprises displaying the first bid data.

6. An option auction system comprising:
a network;
a display operatively connected to the network;
a memory in which command instructions are stored; and
a processor configured to execute the command instructions to store tax credit data associated with future development of a real property, store option data associated with an obtained option, associate the stored option data with the stored tax credit data, retrieve the stored option data and the stored tax credit data, display the retrieved data, request an offer for the option associated with the displayed data, and store a received offer to purchase the obtained option.

7. The system of claim 6, wherein the processor is further configured to execute the command instructions to
store regulatory data associated with the real property,
associate the stored regulatory data with the stored option data,
retrieve the stored regulatory data, and
display the retrieved regulatory data.

8. The system of claim 6, wherein the processor is further configured to execute the command instructions to
store municipal contact data associated with the real property;
associate the stored municipal contact data with the stored option data,
retrieve the municipal contact data, and
display the retrieved municipal contact data.

9. The system of claim 6, wherein the processor is further configured to execute the command instructions to
store surrounding area survey data associated with the real property,
associate the stored surrounding area survey data with the stored option data,
retrieve the surrounding area survey data, and
display the retrieved surrounding area survey data.

10. The system of claim 6, wherein the processor is further configured to execute the command instructions to
store first bid data for the option,
retrieve the first bid data, and
display the first bid data.

11. An option auction system comprising:
a network connection;
a memory in which command instructions are stored; and
a processor configured to execute the command instructions to (i) store development data for a plurality of real properties, (ii) store a plurality of option data, each of the plurality of option data associated with an obtained option for an associated one of the plurality of real properties, (iii) associate the stored development data with the associated real property, (iv) retrieve the plurality of real properties and the associated stored development data, (v) transmit the retrieved plurality of real properties and the associated stored development data through the network connection, (vi) request a plurality of offers, each of the requested plurality of offers associated with one of the retrieved plurality of real properties, (vii) store a received offer to purchase one of the retrieved plurality of real properties.

12. The system of claim 11, wherein the development data comprises:
data unique to each of the plurality of real properties; and
general data applicable to each of the plurality of real properties.

13. The system of claim 12, wherein the data unique to each of the plurality of real properties comprises data associated with the potential for receiving tax credits for the development of each of the plurality of real properties.

14. The system of claim 13, wherein the general data comprises one or more of:
contact data;
legal data; and
data associated with the area surrounding the property.

15. The system of claim 14, wherein the general data comprises:
contact data;
legal data; and
data associated with the area surrounding the property.
